(19) United States
(12) Patent Application Publication
(10) Pub. No.: US 2016/0288444 A1
(43) Pub. Date: Oct. 6, 2016

(54) METHOD FOR HANDLING AND DRYING CARDBOARD TUBES

(71) Applicant: ABZAC CANADA INC., Drummondville (CA)

(72) Inventor: Pierre-Michel D'Anglade, Montréal (CA)

(21) Appl. No.: 15/035,874

(22) PCT Filed: Dec. 5, 2014
(86) PCT No.: PCT/CA2014/051171

§ 371 Date: May 11, 2016

Related U.S. Application Data
(60) Provisional application No. 61/912,852, filed on Dec. 6, 2013.

(51) Int. Cl. B31C 11/06

(52) U.S. Cl. CPC B31C 11/06

(57) ABSTRACT

A method for handling and drying cardboard tubes. The method includes the steps of receiving the cardboard tubes in a horizontal orientation at the exit of a conveyor, the cardboard tubes having respective sidewalls wet from a previous winding and gluing process, the sidewalls having a given moisture level;

successively grouping the cardboard tubes in perforated boxes by preserving the horizontal orientation, the perforated boxes having at least two opposed lateral sides provided with openings, the cardboard tubes having respective extremities facing said openings; placing the perforated boxes into an air dryer with the cardboard tubes aligned with an air flow of the dryer; drying the cardboard tubes by circulating air in the dryer through said perforated boxes for a predetermined time period, lowering the moisture level of the cardboard tubes; and using the perforated boxes for shipment of the cardboard tubes.

### FIELD OF THE INVENTION

The present invention relates to the field of paper and cardboard tube manufacturing, and more particularly relates to a method for handling and drying manufactured paper and cardboard tubes from a supplier to a customer.

### BACKGROUND OF THE INVENTION

Many factors have put pressure on manufacturers and suppliers to reduce their costs in order to deliver products at competitive prices. This is unequivocally the case for paper and cardboard tube manufacturers.

The manufacturing of spiral or radial wound tubes requires helical or concentric winding of multiple strips of paper or cardboard. An adhesive is applied to bind the multiple strips of cardboard together in order to create wound tubes. The tubes are manufactured in various ranges of length and diameters, in addition to various thickness and material specifications. However, the solutions known in the art are not well adapted for shorter tubes, generally having a length of 80 cm or less.

Typically, at the exit of the winding process, as shown in FIG. 1, the wound tubes are grouped in horizontal bundles using plastic strips. This configuration is generally unstable for shorter tubes and the adhesive binding tends to loosen under the weight of the tubes.

Following the winding process, a drying process generally takes place. In an industrial dryer, like the one shown in FIG. 2, the shorter tubes may be placed vertically. Alternatively, the shorter tubes are palletized with plastic strips to hold the tubes together and the pallets are stacked as shown in FIG. 3. However, the pallet stability is in part dependant on the length of the tubes. That is to say that palletizing shorter tubes poses stability concerns.

Alternatively, the shorter tubes may be placed on racks, like the one show in FIG. 4. The racks are then placed in a dryer where the space within the dryer is fully utilized and subsequently the batch size within the dryer is maximized.

When the tubes are dried in large metallic racks, the same racks as shown in FIG. 4 can be used for transporting the tubes from the manufacturer to the customer. However, the use of racks is generally only possible when the customer has sufficient warehouse space and the distance between the manufacturer and the customer is relatively short, in order to minimize transportation costs, given the weight of the racks.

Advantageously, the use of racks as described above minimizes the amount of handling as the tubes remain horizontally disposed throughout the post-winding processes. In other words, labour costs are minimized as a change in tube orientation often results in additional product handling and subsequently increases an already expensive labour cost.

However, the use of racks occupies substantial amounts of valuable space both for the manufacturer and for the customer who keeps the large racks on-site until the tubes are depleted and the stocks are replenished by the manufacturer. The empty racks occupy the same amount of storage space as full racks. Adversely, the racks being tied up at the customer's site also restricts shipping capacity for the manufacturer as the racks needed are unavailable. These drawbacks create bottlenecks in the supply chain and further incur hidden costs. It is also noteworthy that the use of racks involves a capital investment as the racks must be customized and not all customers are equipped to handle these types of racks.

It is also known that the moisture level in a wound tube is dependent on the tube's length, with about an increase of 0.12% of the length of the tube per one percentage of moisture content in the tube. This means that, a cardboard tube having a length of 30 cm with sidewalls having a moisture level of 10% will see its length increased to 30.036 cm if the moisture level in its sidewalls increases to 6%. Therefore, it is important that the moisture level in the sidewalls of cardboard tubes be uniform so that the respective lengths of the cardboard tubes do not vary from one tube to the other within the same batch. Normally, in a horizontal position on racks for instance, the end of a shorter tube closest to the drying vents is often very dry, whereas its opposite end is only sufficiently dry. This results in a moisture variance of about 1.2% over the length of the tube. Since the length of a tube after the drying process is directly related to the tube's moisture content, a higher moisture content generally results in longer tubes. If the tubes of a batch are not dried uniformly, the length of the respective tubes within the batch will likely vary. This situation is undesirable since the tubes are often used in winding machines for the packaging of plastic films, and these winding machines have tight tolerances with regard to the length of the cardboard tubes

Thus, known methods for drying, storing and transporting manufactured tubes lack the full set of attributes needed for obtaining uniformly dried tubes, minimizing the handling of tubes, stabilizing pallets for both safe storage and transportation, avoiding damaged product, and debottlenecking the supply of tubes in order to increase productivity and satisfy the needs of the customer. Therefore, there exists a need in the art for a method for handling and drying manufactured paper and cardboard tubes from a supplier to a customer, preferably adapted to shorter tubes, which alleviates at least some of the drawbacks of the prior art.

### SUMMARY OF THE INVENTION

One aspect of the present invention is to provide a method for handling and drying cardboard tubes to satisfies at least some of the above-mentioned needs and is thus an improvement over other methods known in the prior art.

In accordance with the present invention, the above mentioned object is achieved, as will be easily understood, by a method for handling and drying cardboard tubes such as the one briefly described herein and such as the one exemplified in the accompanying drawings.

More particularly, and according to an aspect of the invention, there is provided a method for handling and drying cardboard tubes comprising the steps of:

receiving the cardboard tubes in a horizontal orientation at the exit of a conveyor, the cardboard tubes comprising respective sidewalls wet from a previous winding and gluing process, the sidewalls having a given moisture level;

successively grouping the cardboard tubes in perforated boxes by preserving the horizontal orientation, the perforated boxes having at least two opposed lateral sides provided with openings, the cardboard tubes having respective extremities facing said openings;

placing the perforated boxes into an air dryer with the cardboard tubes aligned with an air flow of the dryer;

drying the cardboard tubes by circulating air in the dryer through said perforated boxes for a predetermined time period, lowering the moisture level of the cardboard tubes; and

using the perforated boxes for shipment of the cardboard tubes.

The cardboard tubes can be dried until the moisture level in the sidewall of at least one of the cardboard tubes is below 7%, and more preferably, less than 6%.

The cardboard tubes can also be dried until they reach a moisture variance of less than 0.75% over a length of at least one of the cardboard tubes, the moisture being measured in the sidewall of said at least one cardboard tube.

In some embodiments, the method further includes a step of packaging the perforated boxes.

After shipment of the cardboard tubes at a remote location, in some other embodiments, the method further includes a step of collapsing and reusing the perforated cardboard boxes for handling and drying additional cardboard tubes.

In some embodiments, the perforated boxes can be stacked in columns inside the air dryer, the columns being spaced apart between 5 to 20 cm and preferably by at least 10 cm, thereby creating turbulence in the air flow. The air flow inside the dryer can be heated.

In some embodiments, the cardboard tubes can comprise radial wound paper tubes.

In some embodiments, the length of the cardboard tubes is preferably less than 80 cm, and more preferably less than 40 cm

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of longer tubes at the exit of the winding process, where the tubes are grouped in bundles on a conveyor, in accordance with the prior art.

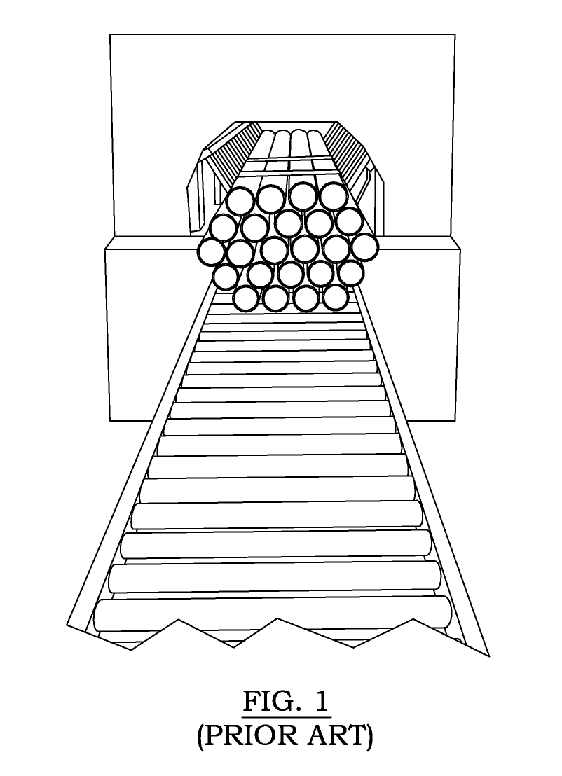

FIG. 2 is a front view of the inside of an industrial dryer used for drying tubes.

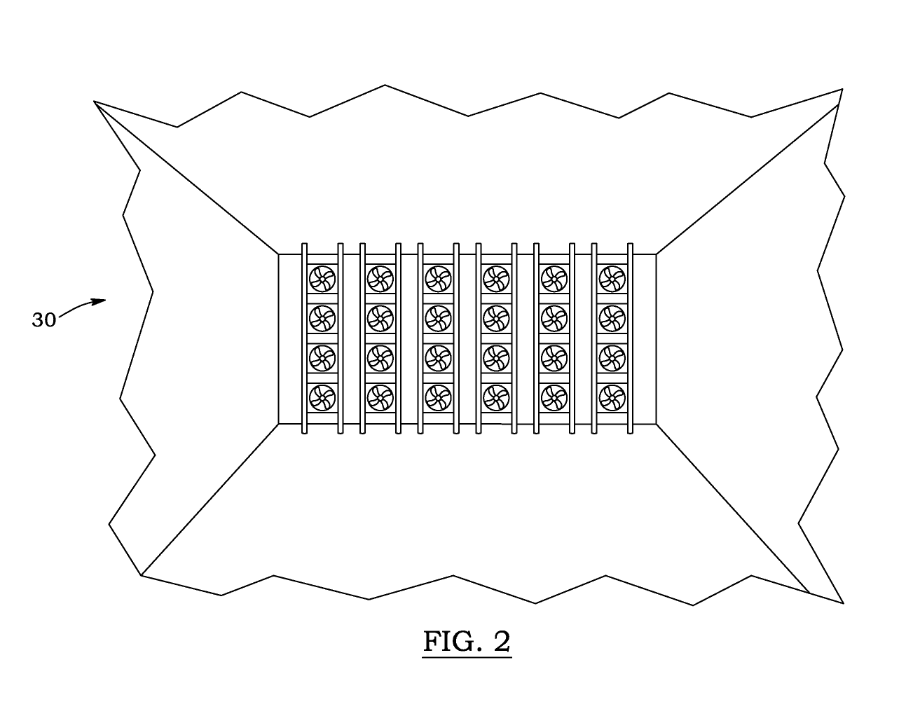

FIG. 3 is a front view of tubes on stacked pallets with plastic strips to hold the tubes together, in accordance with the prior art.

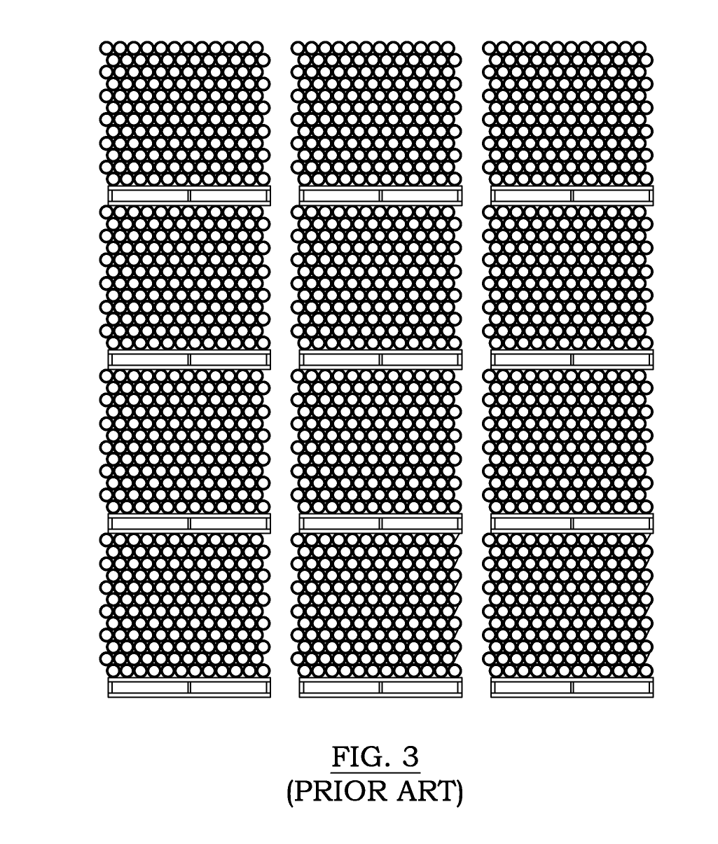

FIG. 4 is a front view of tubes stored on large metallic racks.

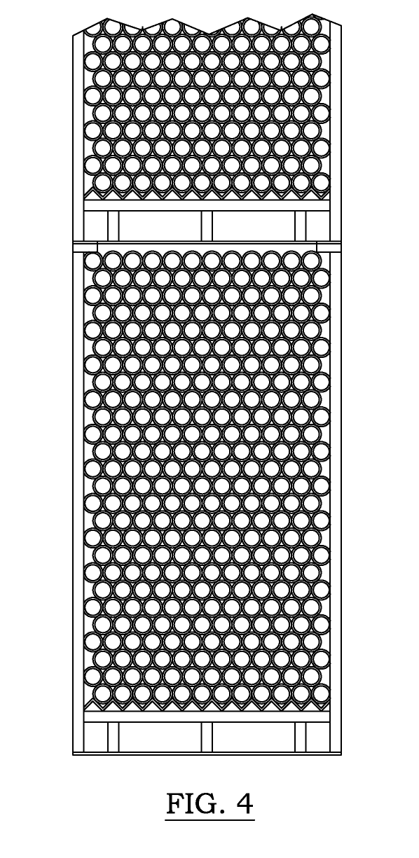

FIG. 5 is a flow chart of a method for handling and drying cardboard tubes in accordance with an embodiment of the present invention.

FIG. 6 is a perspective view of a perforated box in accordance with an embodiment of the present invention.

FIG. 7 is a perspective view of the perforated box of FIG. 6 with cardboard tubes placed inside of the perforated box.

FIG. 8 is a side view of the perforated box of FIG. 6.

FIG. 9 is a perspective view of the perforated box of FIG. 6, in a collapsed position.

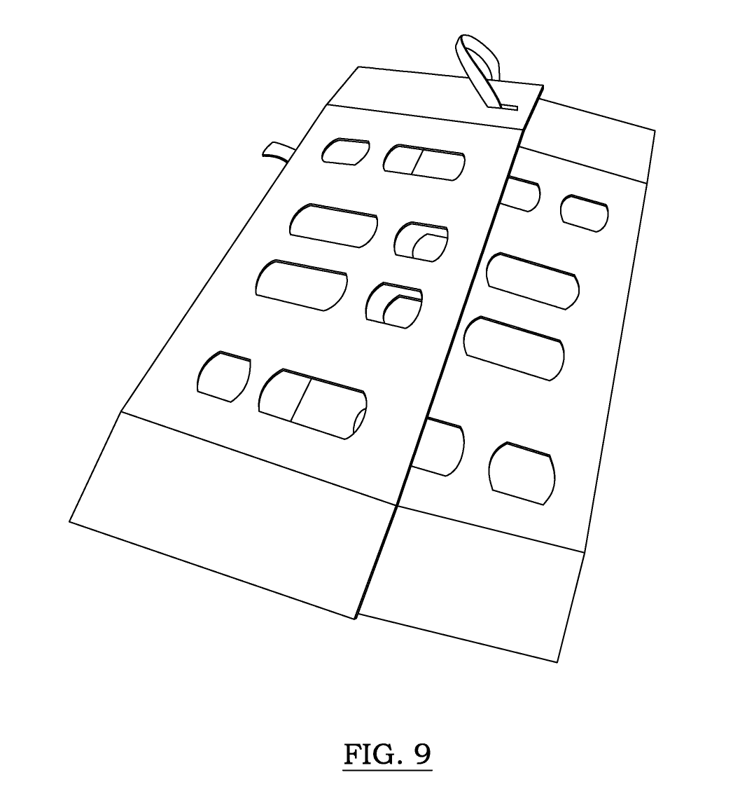

### DETAILED DESCRIPTION OF PREFERRED EMBODIMENTS OF THE INVENTION

In the following description, the same numerical references refer to similar elements. Furthermore, for the sake of simplicity and clarity, namely so as to not unduly burden the figures with several references numbers, not all figures contain references to all the components and features of the present invention and references to some components and features may be found in only one figure, and components and features of the present invention illustrated in other figures can be easily inferred therefrom. The embodiments, geometrical configurations, materials mentioned and/or dimensions shown in the figures are preferred, for exemplification purposes only.

Moreover, in the context of the present invention, the expression “tube” is intended to refer to tubes crafted in an industrial operation. The tubes refer to hollow cylinders that may be further used for containing materials or as an axle for supporting materials. In the case of the axle, the tube is often referred to as a mandrel. The tubes are generally manufactured using spiral or radial technologies, as known in the art, for helically or concentrically winding multiple strips of paper or cardboard, by applying an adhesive to bind the multiple strips together during the manufacturing process.

The expression “cardboard” is intended to refer to a material made of pressed paper pulp or pasted sheets made from paper pulp and used in the manufacturing of wound tubes.

Furthermore, the expression “drying” is intended to refer to any process by which moisture is removed or extracted. This process generally takes place in an industrial dryer with fans circulating or pushing air in and around the cardboard tubes. Air within the dryer is circulated with sufficient turbulence to enable proper drying of the tubes.

Furthermore, the expression “packaging” is intended to refer to any wrapping process.

Furthermore, the expressions “wrap” and “wrapping” are used in the sense of covering, enclosing or enveloping.

Furthermore, the expression “palletizing” is intended to refer to placing materials on pallets for moving or storing.

Furthermore, the expression “horizontal orientation” is intended to refer to the orientation of the cardboard tubes at the exit of a conveyer.

Furthermore, the order of the steps of the method described herein should not be taken as to limit the scope of the invention, as the sequence of the steps may vary in a number of ways, without affecting the scope or working of the invention, as can also be understood.

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. As such, it is to be understood that the description set forth herein is merely exemplary to the present invention and is not intended to limit the scope of protection.

Broadly described, the handling and drying method according to the present invention, as shown in the accompanying drawings, is an improved method for handling and drying cardboard tubes in order to reduce manufacturing costs while improving the quality of the product.

According to an aspect of the invention, there is provided a method for handling and drying cardboard tubes.

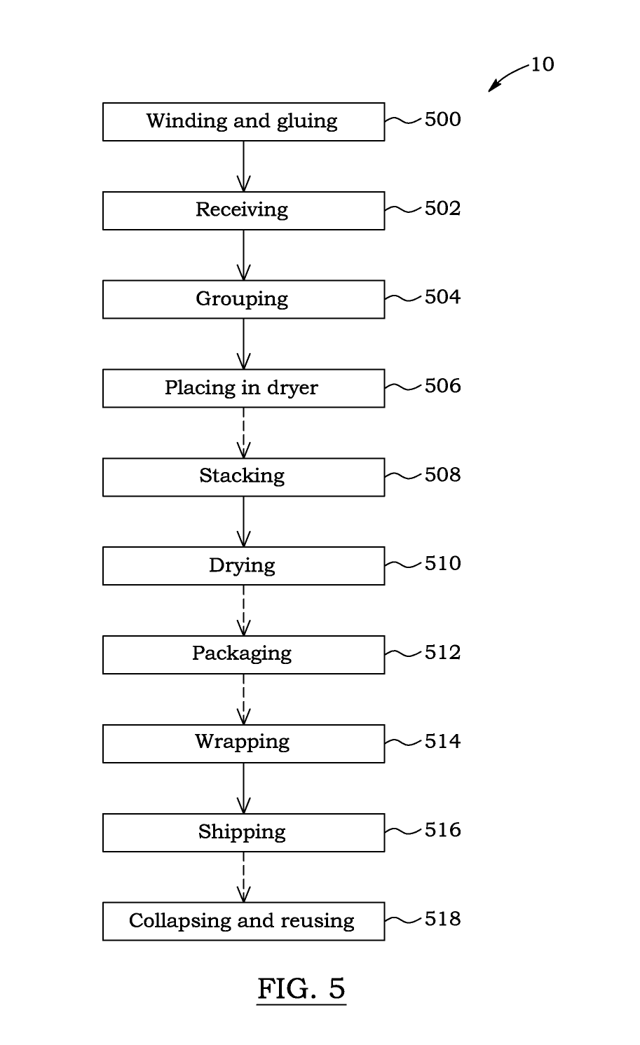

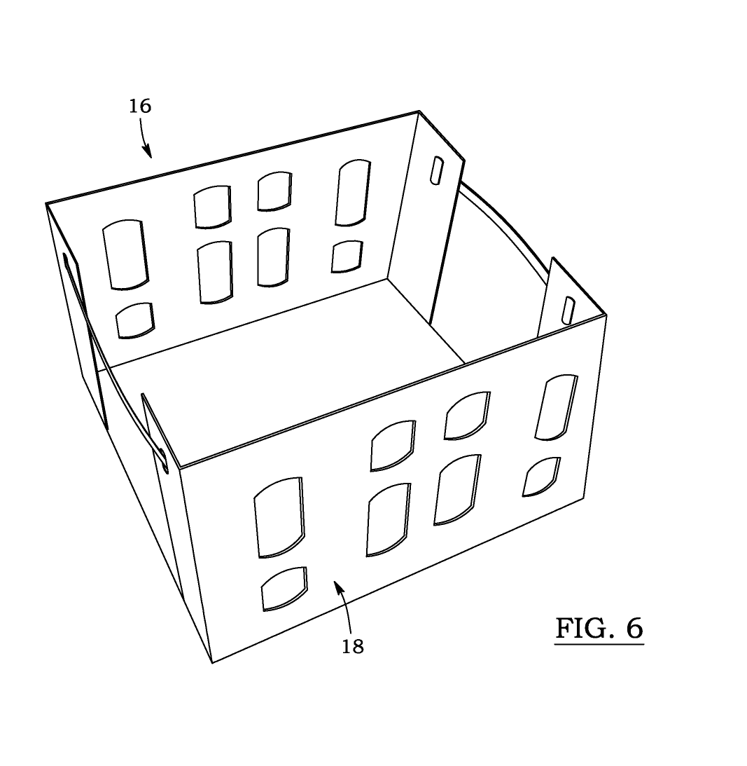

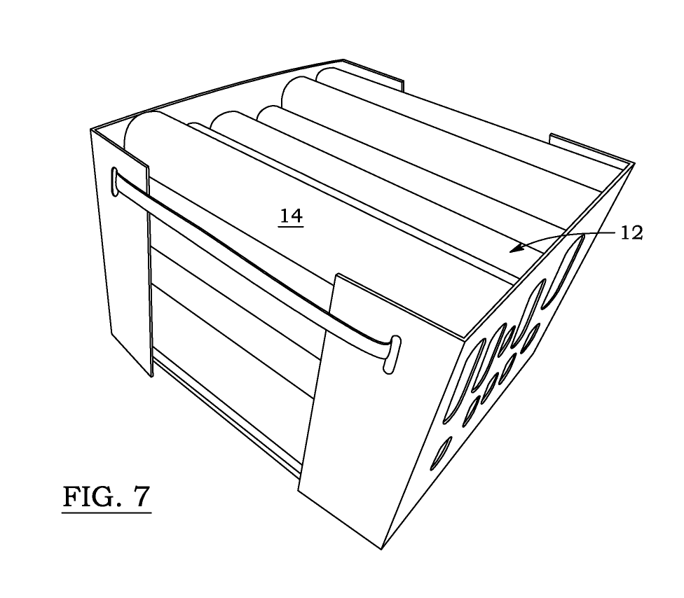

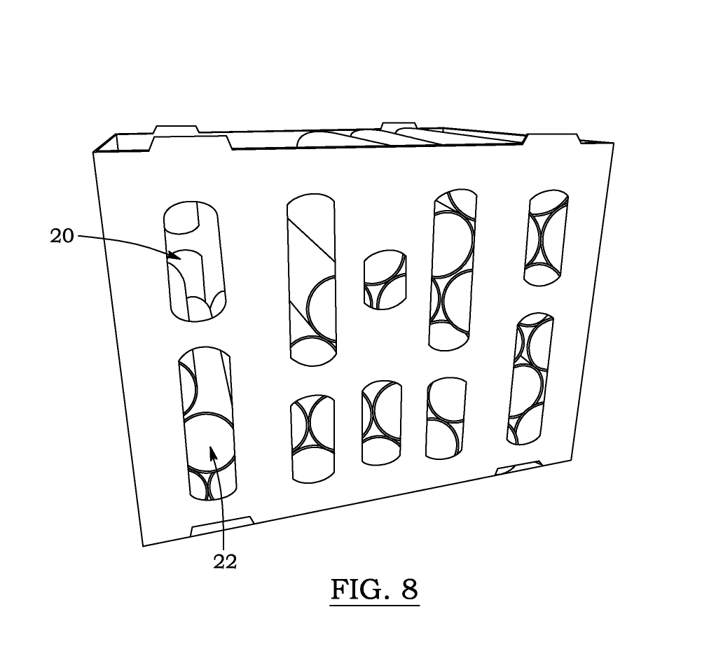

Referring to FIGS. 5 to 8, the method 10 begins with step 502, which consists in receiving the cardboard tubes 12 in a horizontal orientation at the exit of a conveyor. The cardboard tubes 12 have respective sidewalls 14 wet from a previous winding and gluing process, identified in step 500, wherein the sidewalls 14 have a given moisture level. Step 500 is an optional step of the method. The cardboard tubes 12 are then successively grouped, as per step 504, in perforated boxes 16 by preserving their horizontal orientation. The perforated boxes 16 have at least two opposed lateral sides 18 provided with openings 20. When conducting step 504, the respective extremities 22 of the cardboard tubes 12 are placed so as to face said openings 20. The next step 506 of the method 10, consists in placing the perforated boxes 16 into an air dryer 30 with the cardboard tubes 12 aligned with an air flow of the dryer 30. The next step 510 consists of drying the cardboard tubes 12 by circulating air in the dryer 30 through the perforated boxes 16 for a predetermined time period, and thus lowering the moisture level of the cardboard tubes 12. At step 516, the perforated boxes 16 are then used for shipment of the cardboard tubes 12.

The method 10 can further include, after step 506 of placing the perforated boxes 16 inside the dryer 30, a step 508 of stacking the perforated boxes 16 in columns, the columns being spaced apart by at least 10 cm, thereby facilitating the creation of turbulence in the air flow. Advantageously, this results in a more uniformed drying with a moisture variance of less than 0.75% over the length of the cardboard tubes 12.

The method 10 can further include, after step 51—of drying the cardboard tube 12, a step 512 of packaging the perforated boxes 16.

The method 10 can further include, after step 510 of drying the cardboard tube 12, a step 514 of wrapping the perforated boxes 16 with a plastic film.

The method 10 can further include, after the step 516 of shipping the cardboard tubes 12 at a remote location, a step 518 of collapsing and reusing, the perforated cardboard boxes 16 being for handling and drying additional cardboard tubes 12. The collapsing of the perforated box 16 would occur when the perforated box 16 is emptied and would occur without much effort. The reusing of the perforated box 16 may be for the same purposes as described in the method 10.

Preferably, the drying step 510 is carried out until the moisture level in the sidewall 14 of at least one of the cardboard tubes 12 is below 7%, preferably less than 6%, and/or until reaching a moisture variance of less than 0.75% over a length of at least one of the cardboard tubes 12, the moisture being measured in the sidewall 14 of said at least one cardboard tube 12.

If is preferred that the air flow inside the dryer 30 is heated to accelerate drying 510 the cardboard tubes 12.

Preferably, the cardboard tubes 12 consists of radial wound paper tubes.

Preferably, the length of the cardboard tubes 12 is less than 80 cm.

Advantageously, the use of perforated boxes according to embodiments of the invention allow for uniform drying of the tubes in addition to reducing the amount of product handling. Other benefits of the method according to embodiments of the invention relate to more stable packaging, which better protects the tubes during storage and transportation. Furthermore, supplying the tubes to the customer in the perforated boxes eliminates the need for rack or bundles and greatly simplifies the current procedures for both the supplier and the customer. The perforated boxes also weigh less than the heavy metallic racks which may provide reduced transportation costs and a smaller environmental footprint.

Advantageously, the method according to various embodiments of the invention allow for uniform drying and supplying of tubes with reduced handling, raw material, packaging and inventory costs on the manufacturer's end. In turn, this allows the manufacturer to increase productivity and supply tubes at competitive prices.

Another advantage of the method according to various embodiments of the invention is that it minimizes the handling steps because the tubes are kept in the same orientation, from the exit of the winding machine, to the dryer, to the pallet and onto the customer.

Additionally, not having to additionally handle the tubes may result in savings of 10% to 15% on the cost of manufactured tubes and savings of 5% on faulty product. Additionally, being able to uniformly dry the tubes may provide savings of 25% on raw material costs.

Of course, numerous modifications could be made to the above-described embodiments without departing from the scope of the invention, as apparent to a person skilled in the art.

1. A method for handling and drying cardboard tubes, comprising the steps of:
(a) receiving the cardboard tubes in a horizontal orientation at the exit of a conveyor, the cardboard tubes comprising respective sidewalls wet from a previous winding and gluing process, the sidewalls having a given moisture level;
b) successively grouping the cardboard tubes in perforated boxes by preserving the horizontal orientation, the perforated boxes having at least two opposed lateral sides provided with openings, the cardboard tubes having respective extremities facing said openings;
c) placing the perforated boxes into an air dryer with the cardboard tubes aligned with an air flow of the dryer;
d) drying the cardboard tubes by circulating air in the dryer through said perforated boxes for a predetermined time period, lowering the moisture level of the cardboard tubes; and
e) using the perforated boxes for shipment of the cardboard tubes.

2. The method as claimed in claim 1, wherein in step d), drying the cardboard tubes is performed until the moisture level in the sidewall of at least one of the cardboard tubes is below 7%.

3. The method as claimed in claim 1, wherein in step d), drying the cardboard tubes is performed until reaching a moisture variance of less than 0.75% over a length of at least one of the cardboard tubes, the moisture being measured in the sidewall of said at least one cardboard tube.

4. The method as claimed in of claim 1, wherein in step e) comprises packaging the perforated boxes.

5. The method as claimed in claim 4, wherein said step e) comprises wrapping the perforated boxes with a plastic film.

6. The method as claimed in claim 1, further comprising a step f) performed after shipment of the cardboard tubes at a remote location, said step f) comprising collapsing and reusing the perforated cardboard boxes for handling and drying additional cardboard tubes.

7. The method as claimed in claim 1, wherein in step c), the perforated boxes are stacked in columns, the columns being spaced apart by at least 10 cm, thereby creating turbulence in the air flow.

8. The method as claimed in claim 1, wherein in step d), the air flow inside the dryer is heated.

9. The method as claimed in claim 1, wherein the cardboard tubes comprise radial wound paper tubes.

10. The method as claimed in claim 1, wherein length of the cardboard tubes is less than 80 cm.
